(19) United States
(12) Patent Application Publication
(10) Pub. No.: US 2013/0287120 A1
(43) Pub. Date: Oct. 31, 2013

(54) BITRATE ESTIMATION DEVICES AND BITRATE ESTIMATION METHODS THEREOF

(71) Applicants: Nyeong-Kyu KWON, Daejeon (KR); Byeungwoo JEON, Suwon-si (KR); Yowon JEONG, Yongin-si (KR); Daeyun PARK, Suwon-si (KR); Jungyoup YANG, Suwon-si (KR); Kwanghyun WON, Suwon-si (KR)

(72) Inventors: Nyeong-Kyu KWON, Daejeon (KR); Byeungwoo JEON, Suwon-si (KR); Yowon JEONG, Yongin-si (KR); Daeyun PARK, Suwon-si (KR); Jungyoup YANG, Suwon-si (KR); Kwanghyun WON, Suwon-si (KR)

(21) Appl. No.: 13/796,293

(22) Filed: Mar. 12, 2013

Related U.S. Application Data
(60) Provisional application No. 61/640,071, filed on Apr. 30, 2012.

(30) Foreign Application Priority Data
Apr. 30, 2012 (KR) 10-2012-0045610

(51) Int. Cl. H04N 7/26

(52) U.S. Cl. CPC H04N 19/00527
USPC 375/240.26

(57) ABSTRACT

A bitrate estimation method includes: calculating a number of symbol bins of a received syntax element; deciding average bit amount corresponding to the number of symbol bins using a look-up table; and estimating a bitrate based on the number of symbol bins and the average bit amount. Bitrate estimation methods and corresponding devices have improved operation speed, accuracy and/or simplified computation.

### CROSS-REFERENCE TO RELATED APPLICATIONS

This U.S. non-provisional patent application claims priority under 35 USC §119 to Korean Patent Application No. 10-2012-0045610, filed on Apr. 30, 2012, and to Provisional Application No. 61/640,071, filed on Apr. 30, 2012, the entirety of each of which is hereby incorporated by reference.

### BACKGROUND

General inventive concepts relate to bitrate estimation devices and bitrate estimation methods thereof. More specifically, for example, one or more inventive concepts are directed to bitrate estimation devices for context-based adaptive binary arithmetic coding devices and bitrate estimation methods thereof.

H.264/AVC is a video coding standard developed through a collaboration of MPEG (Moving Picture Experts Group) of ISO/ICE and VCEG (Video Coding Expert Group) of ITU-T. This standard is advantageous in environmental adaptation and video compression efficiency compared with conventional video compression standards. One of the coding methods in the H.264/AVC standard is a context-based adaptive binary arithmetic coding (hereinafter referred to as “CABAC”).

In the H.264/AVC, a rate-distortion cost function (J=D+AR) is used as a reference for improving coding mode decisions. In this formula, D represents a distortion between an original image and a reconstructed image, R represents a bitrate of a coded bitstream, and λ represents a lagrange multiplier on a relative weight factor. In order to apply a rate-distortion cost function to a coding mode, a coding device should code an input signal to detect a bitrate of an output bitstream. However, obtaining a bitrate R through a practical coding procedure of the coding device may cause excessive overhead on a system. Because CABAC performs entropy encoding that requires complex computation, the overhead caused while obtaining a bitrate R has become an issue.

There have been proposed bitrate estimation methods in which some of coding steps of COBAC are omitted to reduce computational complexity. Conventional bitrate estimation methods are disclosed in the References “Efficient CABAC Rate Estimation for H.264/AVC Mode Decision”, IEEE Trans. CSVT Feb. 2010 and “Efficient Bit-Rate Estimation Technique for CABAC”, APCCAS 2008. Unfortunately, conventional bitrate estimation methods still require complex computation or exhibits considerably low accuracy of an estimated bitrate R.

### SUMMARY

One or more inventive concepts provide bitrate estimation methods for estimating a bitrate of a coding device.

In at least on example embodiment, a bitrate estimation method includes: calculating a number of symbol bins of a received syntax element; determining an average bit amount corresponding to the number of symbol bins using a look-up table; and estimating a bitrate based on the number of symbol bins and the average bit amount.

According to at least one other example embodiment a method for estimating a bitrate of a context-based binary arithmetic (CABAC) device includes: selecting a context model of a received syntax element; calculating a statistical parameter of the context model based on the context model; and determining a bitrate corresponding to the statistical parameter using a look-up table.

At least one other example embodiment provides a method for estimating a bitrate of a coding device, the method comprising: estimating the bitrate of the coding device based on a number of symbol bins of a received syntax element without calculating bit probabilities for the symbol bins of the received syntax element.

At least one other example embodiment provides a bitrate estimation device comprising: a bitrate calculating unit (also referred to as a bitrate calculator) configured to calculate an estimated bitrate of a coding device based on a number of symbol bins of a received syntax element, but without calculating bit probabilities for the symbol bins of the received syntax element.

At least one other example embodiment provides a method for estimating a bitrate of a coding device, the method comprising: estimating the bitrate of the coding device based on a calculated number of symbol bins of a received syntax element and an average bit amount for the symbol bins, the average bit amount for the symbol bins being determined using a look-up table.

At least one other example embodiment provides a method for estimating a bitrate of a coding device, the method comprising: identifying a context group of a received syntax element; and estimating the bitrate of the coding device based on a number of symbol bins of the context group, the context group including at least one context model of a context-based adaptive binary arithmetic coding.

According to at least one other example embodiment, a bitrate estimation device comprises: a bitrate calculating unit configured to estimate a bitrate of a coding device based on a calculated number of symbol bins of a received syntax element and an average bit amount for the symbol bins, the average bit amount for the symbol bins being determined using a look-up table.

According to at least one other example embodiment, a bitrate estimation device comprises: a bin counting unit (also referred to as a bin counter) configured to identify a context group of a received syntax element; and a bitrate calculating unit configured to estimate the bitrate of the coding device based on a number of symbol bins of the context group, the context group including at least one context model of a context-based adaptive binary arithmetic coding.

According to at least some example embodiments, calculating the number of symbol bins may include: identifying a context group of the syntax element; and calculating the number of bins of the context group. The context group may include at least one context model of a context-based adaptive binary arithmetic coding (CABAC).

According to at least some example embodiments, identifying a context group may include: determining a binary code corresponding to the syntax element; and determining a context group of the syntax element based on a value of the binary code or a position of the binary code.

According to at least some example embodiments, the context element may be a residual coefficient.

According to at least some example embodiments, identifying a context group may include: determining a first value according to an absolute value of the syntax element; and determining a context group of the syntax element by comparing the first value with a second value.

According to an example embodiment, the syntax element may be a motion vector difference (MVD).

According to at least some example embodiments, calculating the number of symbol bins may further include summing the calculated number of bins of the context group and the number of bins of a feedback signal. The number of bins of a feedback signal may be a normalized number.

According to at least some example embodiments, the look-up table may be defined by a first equation (average bit amount of ‘0’ bit=[log(probability of ‘0’ bit)]/log(0.5)) or a second equation (average bit amount of ‘1’ bit=[log(1−probability of ‘0’ bit)]/log(0.5)). The probability of ‘0’ bit may be determined by a third equation (probability of ‘0’ bit=‘0’ bit number/(‘0’ bit number+‘1’ bit number)).

According to at least some example embodiments, the coding device may be a context-based adaptive binary arithmetic (CABAC) device.

At least one other example embodiment provides a bitrate estimation method for estimating a bitrate of a context-based binary arithmetic (hereinafter referred to as “CABAC”) device. According to at least some example embodiments, the bitrate estimation method may include: selecting a context model of a received syntax element; calculating a statistical parameter of the context model based on the context model; and providing a bitrate corresponding to the statistical parameter using a look-up table.

At least one other example embodiment provides a context-based binary arithmetic (CABAC) device comprising: a bitrate estimation device configured to estimate the bitrate of the CABAC device based on a statistical parameter for a context model of a received syntax element using a look-up table.

At least one other example embodiment provides a method for estimating a bitrate of a context-based binary arithmetic (CABAC) device, the method comprising: estimating the bitrate of the CABAC device based on a statistical parameter for a context model of a received syntax element using a look-up table.

According to at least some example embodiments, the statistical parameter may include an interval of the context model, a bit probability, a most probable symbol or a least portable symbol.

According to at least some example embodiments, the look-up table may be defined based on an equation (bitrate=m−1−└logₙ(i)┘, where i represents an interval, m represents a bit size of the interval, and n represents an antilogarithm of a symbol.

According to at least some example embodiments, the look-up table may be defined based on an interval table of CABAC in the H.264/AVC standard.

According to at least some example embodiments, the bitrate estimation device may further include: a bin counter configured to calculate the number of symbol bins of the received syntax element, the bin counter being further configured to determine an average bit amount corresponding to the number of symbol bins using a look-up table; and wherein the bitrate calculator is configured to estimate the bitrate based on the number of symbol bins and the determined average bit amount.

According to at least some example embodiments, the bin counter may be further configured to identify a context group of the syntax element, and calculate the number of symbol bins of the context group, the context group including at least one context model of a context-based adaptive binary arithmetic coding.

According to at least some example embodiments, the bin counter may be further configured to identify a binary code corresponding to the syntax element, and identify a context group of the syntax element based on a value of the binary code or a position of the binary code.

According to at least some example embodiments, the bitrate estimation device may further include: a bin counter configured to identify a context group of the syntax element, the bin counter being further configured to calculate a number of symbol bins of the received syntax element based on a number of symbol bins of the context group; wherein the context group includes at least one context model of a context-based adaptive binary arithmetic coding.

According to at least some example embodiments, the bin counter may be further configured to identify a binary code corresponding to the syntax element, and identify the context group of the syntax element based on a value of the binary code or a position of the binary code.

According to at least some example embodiments, the bin counter may be further configured to calculate a number of symbol bins of the received syntax element based on the number of bins of the context group; and wherein the bitrate calculator is configured to estimate the bitrate based on the number of symbol bins and an average bit amount for the symbol bins.

According to at least some example embodiments, the average bit amount for the symbol bins may be determined using a look-up table.

According to at least some example embodiments, the statistical parameter may include an interval of the context model, a bit probability, a most probable symbol or a least portable symbol.

### BRIEF DESCRIPTION OF THE DRAWINGS

FIG. 1 is a block diagram of a conventional context-based binary arithmetic (CABAC) device.

FIG. 2 is a block diagram of a conventional bitrate estimation device for CABAC.

FIG. 3 is a block diagram of a bitrate estimation device for CABAC according to an example embodiment.

FIG. 4 is a flowchart illustrating a bitrate estimation method for CABAC according to an example embodiment.

FIG. 5 is a flowchart illustrating a bin counting method of a context group according to an example embodiment.

FIG. 6 is a diagram further illustrating the example embodiment shown in FIG. 5.

FIG. 7 is a flowchart illustrating a bin counting method of a context group according to an example embodiment.

FIG. 8 is a diagram further illustrating the example embodiment shown in FIG. 7.

FIG. 9 is a flowchart illustrating a bin counting method of a context group according to another example embodiment.

FIG. 10 is a flowchart illustrating a bin counting method of a context group according to another example embodiment.

FIG. 11 illustrates an absolute value or the sum of absolute values according to the example embodiments shown in FIGS. 9 and 10.

FIG. 12 is a block diagram of an example embodiment of a bitrate calculating unit shown in FIG. 3.

FIG. 13 illustrates an example first look-up table shown in FIG. 12.

FIG. 14 illustrates an example second look-up table shown in FIG. 12.

FIG. 15 is a block diagram of a CABAC bitrate estimation device according to another example embodiment.

FIG. 16 illustrates an interval table of CABAC in the H.264/AVC standard.

FIG. 17 illustrates a look-up table for a bitrate estimation method according to another example embodiment.

FIG. 18 illustrates a look-up table for a bitrate estimation method according to another example embodiment.

### DETAILED DESCRIPTION

Inventive concepts will now be described more fully hereinafter with reference to the accompanying drawings, in which some example embodiments of inventive concepts are shown. However, the inventive concepts may be embodied in many different forms and should not be construed as limited to the embodiments set forth herein. Rather, these example embodiments are provided so that this disclosure will be thorough and complete, and will fully convey the scope of inventive concepts to those skilled in the art.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams in order not to obscure the example embodiments in unnecessary detail. In other instances, well-known processes, structures and techniques may be shown without unnecessary detail in order to avoid obscuring example embodiments.

Also, it is noted that example embodiments may be described as a process depicted as a flowchart, a flow diagram, a data flow diagram, a structure diagram, or a block diagram. Although a flowchart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, a function, a procedure, a subroutine, a subprogram, etc. When a process corresponds to a function, its termination may correspond to a return of the function to the calling function or the main function.

Moreover, as disclosed herein, the term “buffer,” “memory” or the like, may represent one or more devices for storing data, including random access memory (RAM), magnetic RAM, core memory, and/or other machine readable mediums for storing information. The term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” may include, but is not limited to, portable or fixed storage devices, optical storage devices, and various other mediums capable of storing or containing instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

A code segment may represent a procedure, a function, a subprogram, a program, a routine, a subroutine, a module, a software package, a class, or any combination of instructions, data structures, or program statements.

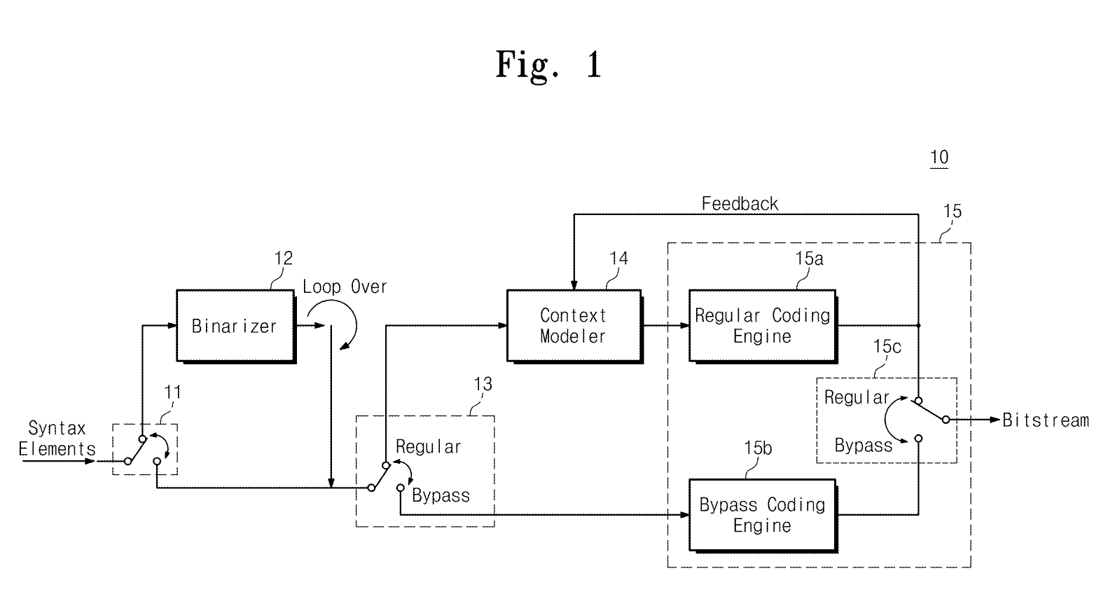

Reference is made to FIG. 1, which is a block diagram of a conventional CABAC device 10. The CABAC device 10 includes a binarizer 12, a context modeler 14, a binary arithmetic coding engine 15, and switches 11 and 13.

The binarizer 12 maps a syntax element to a sequence having a binary value to output a binary symbol when the syntax element rather than a binary value is input. Some of binary symbols output through the binarizer 12 may be coded by a bypass coding engine 15b to be output to a bitstream without passing by the context modeler 14. The other binary symbols may be input to the context modeler 14.

The switches 11 and 13 determine a path along which syntax elements and an output of the binarizer 12 are transmitted. When a binary symbol is input as a context element, the first switch 11 contacts with an underlying node. When the binary symbol is not input as a context element, the first switch 11 contacts an overlying node. The second switch 13 selectively connects the syntax elements or the output of the binarizer 12 to a regular coding path (Regular) or a bypass path (Bypath).

The context modeler 14 performs context modeling of a previous symbol based on an input binary symbol and a previously coded syntax element. The context modeler 14 generates probability information required for coding a currently input binary symbol.

The context modeler 14 generates a probability status value and a most probable symbol (hereinafter referred to as “MPS”) or a least probable symbol (hereinafter referred to as “LPS”). The MPS refers to a high-occurrence-probability symbol among ‘0’ bit or ‘1’ bit, and the LPS refers to a low-occurrence-probability symbol among ‘0’ bit or ‘1’ bit. The context modeler 20 generates a probability state index information based on the probability status value. The context modeler 14 and the context modeling are well known to those skilled in the art and will not be described in further detail.

The binary arithmetic coding engine 15 receives the binary symbol and probability information provided from the context modeler 14 to perform binary arithmetic coding and finally output a bitstream. The binary arithmetic coding engine 15 is well known to the skilled in the art and will not be described in further detail.

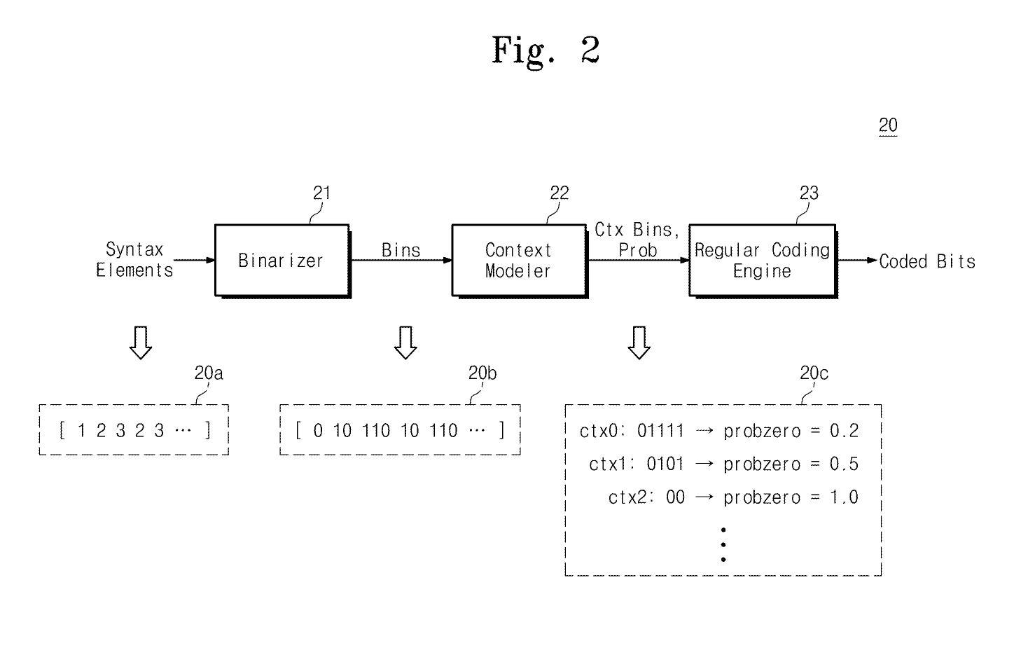

Reference is made to FIG. 2, which is a block diagram of a conventional bitrate estimation device 20 for CABAC. The bitrate estimation device 20 includes a binarizer 21, a context modeler 22, and a regular coding engine 23.

The binarizer 21, the context modeler 22, and the regular coding engine 23 of the bitrate estimation device 20 performs the same or substantially the same functions as the binarizer 12, the context modeler 14, and the regular coding engine 15a shown in FIG. 1, respectively.

For example, when a syntax element is input to the binarizer 21, the binarizer 21 binarizes syntax elements to output binary symbols Bins. The context modeler 22 performs context modeling of the binary symbols Bins and outputs the context-modeled symbols and their bit probabilities. The regular coding engine 23 performs symbol coding with reference to the output symbols and the bit probabilities. Reference boxes 20a, 20b, and 20c exemplarily represent syntax elements, binary symbols Bins, and bit probabilities, respectively.

As described above, the bitrate estimation device 20 is configured to nearly the same or substantially the same operation as the practical CABAC device 10. However, in this case, the bitrate estimation device 20 performs excessively complex computation. An object of the bitrate estimation device 20 is only to estimate a bitrate of CABAC, not to code a practical signal. Accordingly, example embodiments propose a bitrate estimation device 20 configured to estimate a bitrate through different operation and computation than the CABAC device 100.

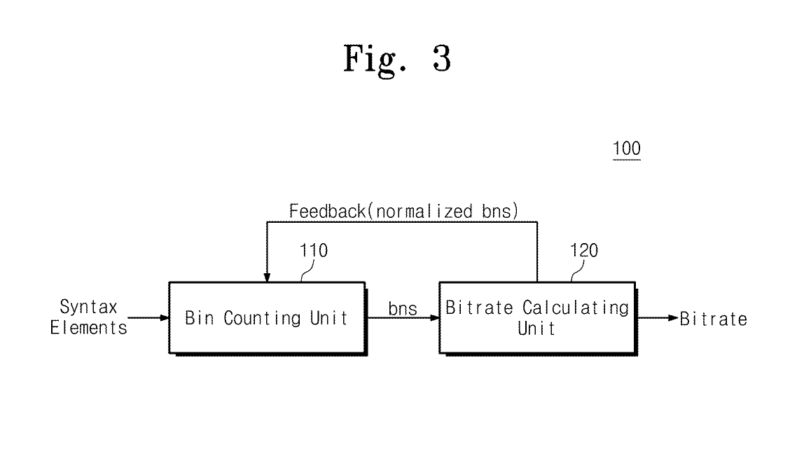

Reference is made to FIG. 3, which is a block diagram of a bitrate estimation device 100 for CABAC according to an example embodiment. The bitrate estimation device 100 includes a bin counting unit (also referred to as a bin counter) 110 and a bitrate calculating unit (also referred to as a bitrate calculator) 120.

The bin counting unit 110 receives syntax elements and calculates the number of symbol bins (bns) of the received syntax elements with reference to a feedback signal. The number of symbol bins (bns) refers to the number of bins of a signal generated by coding a syntax element (e.g., ‘0’ bit number or ‘1’ bit number) or its estimation value. For example, when the bitrate estimation device 100 estimates a bitrate of CABAC, the bns denotes the number of bins in a context model of a syntax element or its estimation value.

The feedback signal indicates the number of bins of a previous syntax element. The number of bins of a previous syntax element is normalized for weighting to be output as a feedback signal.

The bin counting unit 110 performs coding operations of CABAC after omitting or simplifying some of the coding operations to achieve simplification of computation.

Specifically, the bin counting unit 110 sets context groups which group context models of CABAC. The bin counting unit 110 performs context modeling of syntax elements using the context groups to further simplify the syntax elements. Each of the context groups includes at least one of the context models of CABAC. The context models of CABAC are determined by the CABAC in the H.264/AVC standard.

According to at least some example embodiments, the context models are grouped with reference to two standards. First, one context group groups adjacent context models for one syntax element. As context models of CABAC in the H.264/AVC standard are closely adjacent to each other, their bit probabilities (e.g., ‘0’ bit probability or ‘1’ bit probability) become similar to each other. Thus, if the adjacent context models are grouped together, a bit probability error caused by the grouping may be reduced.

Next, the context models for one syntax element are grouped to decrease and/or minimize variation in the number of bins included in a context group. The context models of CABAC in the H.264/AVC standard includes a larger number of bins as the index number decreases. Thus, a context group including a context model with a small number of indices groups a relatively small number of context models.

For example, let it be assumed that there are ten context models ctx0, ctx1, ctx2, . . . , and ctx9 for one syntax element and the context models ctx0, ctx1, ctx2, . . . , and ctx9 are grouped into four context groups ctg0, ctg1, ctg2, and ctg3. Due to the CABAC in the H.264/AVC standard, the context models a larger number of bins as the index number decreases, and context models of adjacent index numbers are similar in bit probability. That is, ctx0 includes a larger number of bits than ctx1 and ctx0 is more similar in bit probability to ctx1 than ctx2.

Accordingly, with reference to the above-described two standards, the respective context models may be exemplarily grouped as the Table (1) below.

TABLE 1

| Context Group [symbol] | Grouped Context Model [symbol] |
|---|---|
| ctg0 [symbol] | ctx0 [symbol] |
| Ctg1 [symbol] | ctx1, ctx2 [symbol] |
| ctg2 [symbol] | ctx3, ctx4, ctx5 [symbol] |
| ctg3 [symbol] | ctx6, ctx7, ctx8, ctx9 [symbol] |

The bin counting unit 110 performs context modeling of each syntax element to a context group through context grouping. That is, syntax elements modeled to the context models ctx1 and ctx2 in original CABAC are modeled to the first context group ctg1 in at least this example embodiment. Similarly, syntax elements modeled to the context models ctx2, ctx4, and ctx5 in original CABAC are modeled to the second context group ctg2 in at least this example embodiment.

As described above, context grouping allows context modeling of syntax elements to be simplified.

Unlike CABAC, the bin counting unit 110 does not calculate a bit probability. The bin counting unit 110 only calculates the number of symbol bins (bns) for syntax elements. In this example, the bitrate of a coding device may be estimated without calculating bit probabilities of symbol bins of received syntax elements.

In at least some example embodiments, the number of symbol bins (bns) is calculated by performing context modeling of syntax elements to decide a context group and summing up the number of bins (e.g., ‘0’ bit number or ‘1’ bit number) of the decided context group.

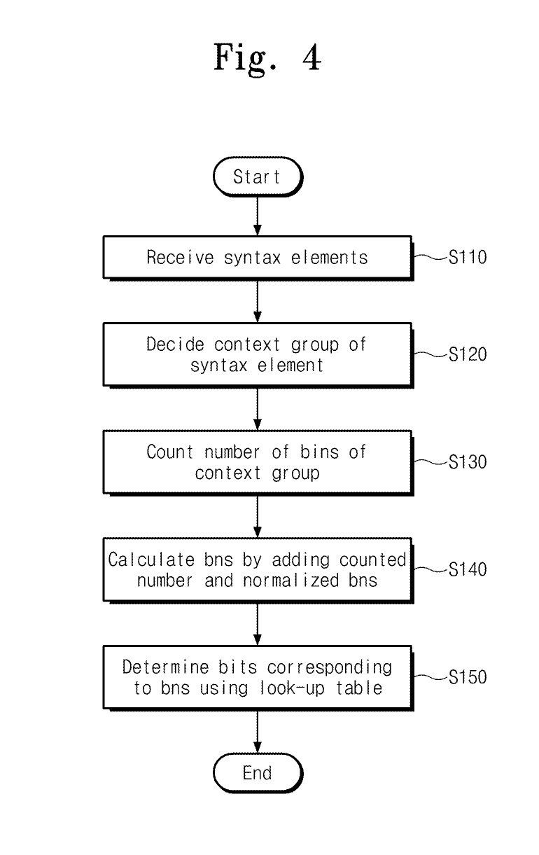

An example method of calculating the number of symbol bins (bns) from syntax elements will be described in detail with reference to FIGS. 4 to 11.

According to the foregoing configuration, the bin counting unit 110 may calculate the number of symbol bins (bns) for syntax elements through simplified computation.

The bin counting unit 120 decides average bit amount corresponding to the number of symbol bins (bns) by using a look-up table (LUT).

In at least some example embodiments, the bitrate calculating unit 120 calculates an estimated bitrate of CABAC by multiplying decided average bit amount by the number of bins. The bitrate calculating unit 120 obtains an estimated bitrate from the number of bins and average bit amount, which may be expressed by Equation (1) below.

Estimated bitrate={(‘0’bit number)×(average bit amount of ‘0’ bit)}+{(‘1’ bit number)×(average bit amount of ‘1’ bit)} Equation (1)

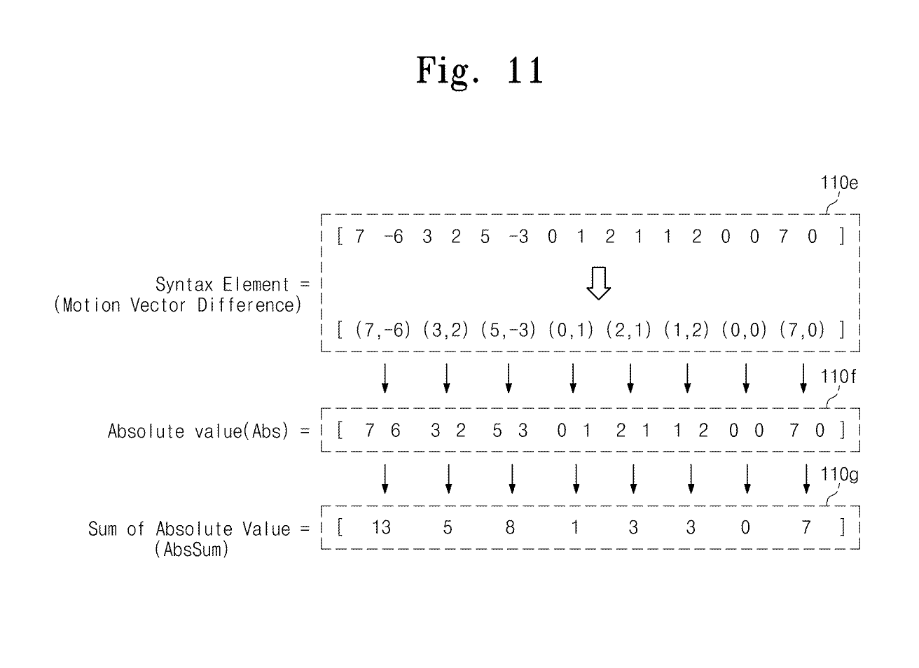

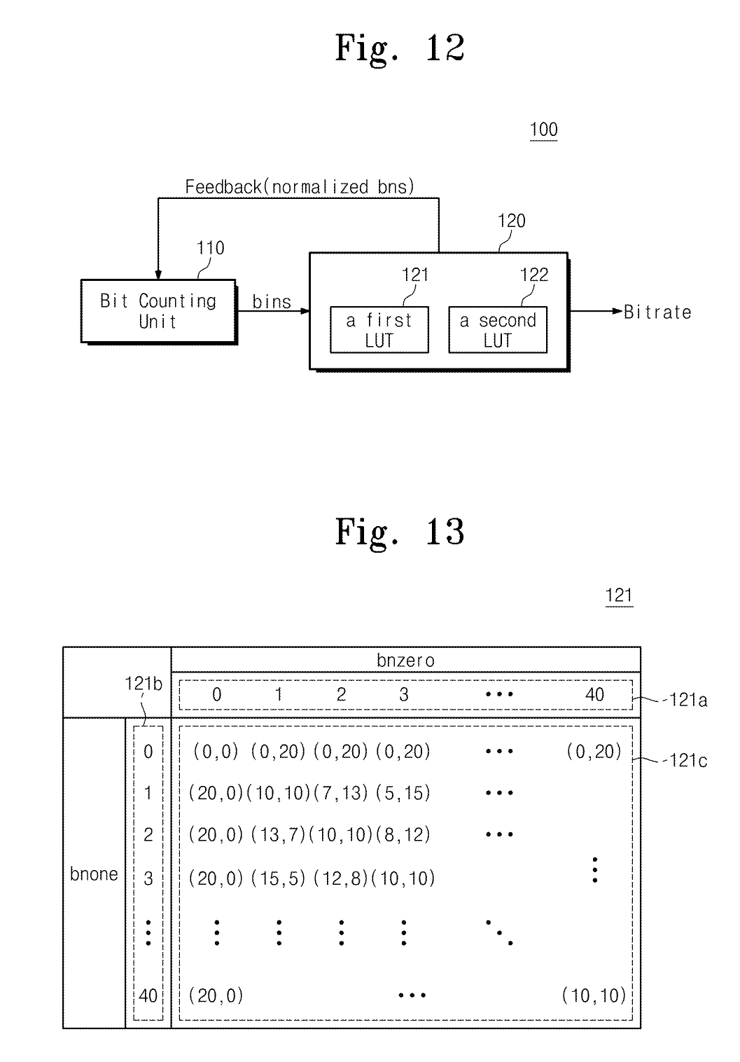

A look-up table of the bitrate calculating unit 120 and a method of deciding average bit amount using the look-up table will be described in detail later with reference to FIGS. 12 to 14.

According to the foregoing configuration, a bitrate estimation device with simplified computation and a bitrate estimation method thereof are provided. In addition, a bitrate estimation speed may be improved. Furthermore, accuracy of the bitrate estimation device and the bitrate estimation method may be enhanced.

Reference is made to FIG. 4, which is a flowchart illustrating an example embodiment of a bitrate estimation method of CABAC. The bitrate estimation method includes S100 to S 150. In the method shown in FIGS. 4, S120 to S140 correspond to calculating the number of binary symbols (bins) of syntax elements.

At S110, a bitrate estimation device (100 in FIG. 3) receives syntax elements. In at least some example embodiments, the syntax element may be a decimal value. Alternatively, the syntax element may be a residual coefficient or a motion vector difference (hereinafter referred to as “MVD”).

At S120, the bitrate estimation device 100 decides a context group for the syntax element. The context group is a grouped version of a context model of CABAC in the H.264/AVC standard and includes at least one context model. The details of the context group are the same or substantially the same as described in FIG. 3.

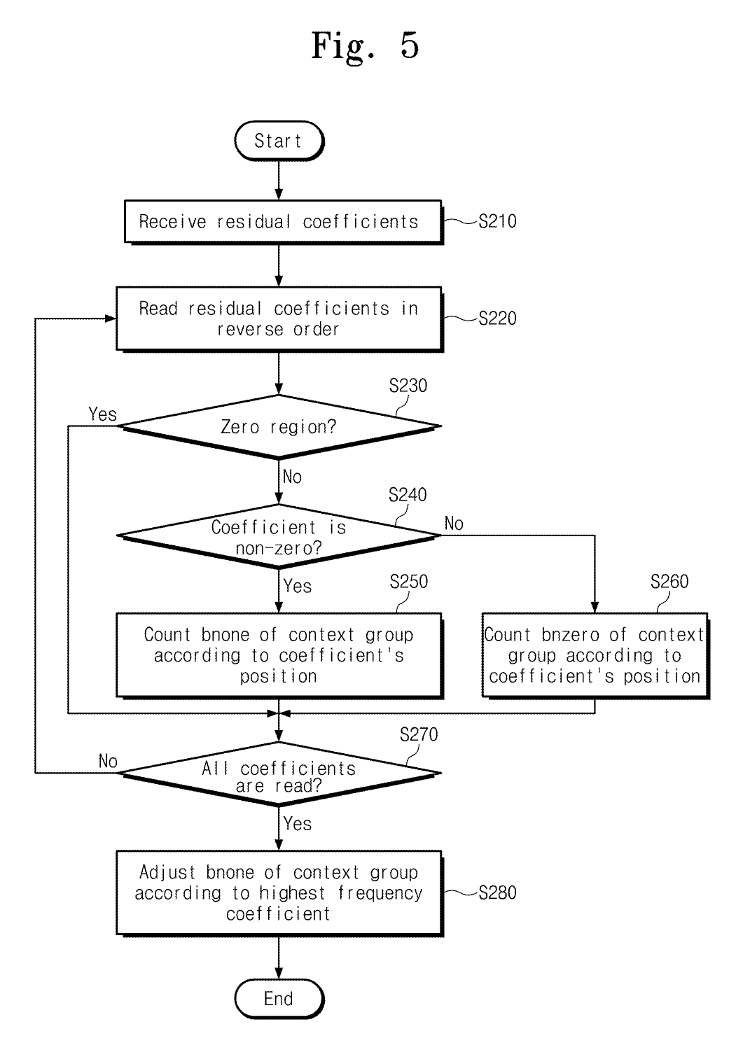

In at least some example embodiments, a method of deciding a context group of syntax elements may vary depending on types of the syntax elements. For example, when a syntax element is a residual coefficient or an MVD a method (or algorithm) of deciding a context group of the residual coefficient may be different from a method of deciding a context group of the MVD. A detailed example embodiment of deciding a context group of a residual coefficient or an MVD will be described in detail later with reference to FIGS. 5 to 11.

At S130, the bitrate estimation device 100 counts the number of bins of a context group. The number of bins includes ‘0’ bit number or ‘1’ bit number of the context group.

At S140, the number of bins of the context group counted in step S130 and the number of normalized symbol bins of the same context group are summed. The sum is supplied as the number of symbol bins (bns, see FIG. 3). The number of normalized symbol bins indicates a normalized value of the number of symbols bins of a previous syntax element supplied as a feedback signal (see FIG. 3).

The bitrate estimation device 100 refers to information of the previous syntax element as a feedback signal to estimate a bitrate of CABAC. In at least some example embodiments, unlike a practical CABAC device, the number of symbols bins of a previous syntax element is received as a feedback signal. Accordingly, when the number of symbols bins of a previous syntax element is excessively large or small, an influence of the previous syntax element on a current syntax element may become excessively great or slight. A weighted signal is provided as a feedback signal to reduce and/or minimize this potential disadvantage. According to at least some example embodiments, as a weighting method, the number of symbol bins of a previous syntax element may be normalized to limit the maximum or minimum number of symbols bins. The normalized number of symbol bins is received as a feedback signal.

An example embodiment of the normalization includes a method in which normalization is carried out such that the sum of ‘0’ bit number and ‘1’ bit number is equal to a given, desired or predetermined constant value.

The number of symbol bins (bns) includes bin number information on respective given, desired or predetermined context groups. For example, the number of symbol bins (bns) includes symbol bin number bns0 on a first context group ctg0, symbol bin number bns1 on a second context group ctg1, symbol bin number bns2 on a third context group ctg2, and symbol bin number bns3 on a fourth context group ctg3. The symbol bins numbers bns0, bns1, bns2, and bns3 may include ‘0’ bit number or ‘1’ bit number of the context groups ctg0, ctg1, ctg2, and ctg3, respectively.

Similarly, a feedback signal includes bin number information on each given, desired or predetermined context group.

In at least some example embodiments, the bitrate estimation device 100 sums ‘0’ bit number of a context group and ‘0’ bit number of a corresponding context group included in a feedback signal (e.g., normalized number of symbol bins). That is, the bitrate estimation device 100 sums ‘0’ bit number of the first context group ctg0 and ‘0’ bit number of the first context group ctg0 of a feedback signal. The bitrate estimation device 100 outputs the sum as ‘0’ bit number of the number of symbol bins (bns0) of the first context group ctg0.

Similarly, the bitrate estimation device 100 sums ‘1’ bit number of a context group and ‘1’ bit number of a corresponding context group included a feedback signal (e.g., normalized number of symbol bins). The bitrate estimation device 100 outputs the sum as ‘1’ bit number of the number of symbol bins of the corresponding context group.

At S150, the bitrate estimation device 100 decides average bit amount corresponding to the number of symbol bins (bns) based on a look-up table. The use of the look-up table allows a log operation and four arithmetical operations for obtaining the average bit amount to be omitted.

Reference is made to FIG. 5, which is a flowchart illustrating a bin counting method of a context group according to an example embodiment. The bin counting method includes S210 to S280.

The example embodiment relates to Significant_coefficient_flag in a context modeling method. In this example embodiment, a syntax element is a residual coefficient.

At S210, a bitrate estimation device 100 receives a residual coefficient as a syntax element. In at least some example embodiments, the residual coefficient is received in the 4×4 block unit. The residual coefficient is the same or substantially the same as that defined in CABAC in the H.264/AVC standard.

At S220, the bitrate estimation device 100 reads received residual coefficients in reverse order. For example, when a residual coefficient is received in 4×4 block unit, the bitrate estimation device 100 first reads a latest-received coefficient and reads a first-received coefficient later. In at least some example embodiments, the bitrate estimation device 100 performs a binarization operation for residual coefficients. In this case, a zero residual coefficient is binarized into ‘0’ and a non-zero residual coefficient is binarized into ‘1’.

At S230, the bitrate estimation device 100 determines whether the read coefficient is positioned in a zero region. The zero region refers to a region directly or immediately before reading a non-zero coefficient from the last coefficient when residual coefficients are read in reverse order. If the residual coefficient is positioned in the zero region, then the flow proceeds to S270. If it is not, then the flow proceeds to S240.

At S240, the bitrate estimation device 100 determines whether the read residual coefficient is a non-zero number. If the residual coefficient is a non-zero number, then the flow proceeds to S250. If it is not, then the flow proceeds to S260.

At S250, the bitrate estimation device 100 counts ‘1’ bit number (bnone) of a context group according to the position of the read residual coefficient. For example, if the read residual coefficient is positioned in a first context group ctg0, ‘1’ bit number of the first context group ctg0 is added by 1. Alternatively, if the read residual coefficient is positioned in the second context group ctg1, ‘1’ bit number of the second context group ctg1 is added by 1. Similarly, when the read residual coefficient is positioned in the third context group ctg2 or the fourth context group ctg3, ‘1’ bit number of the third context group ctg2 or the fourth context group ctg3 is added by 1.

After the ‘1’ bit number of a context group is counted according to the position of the read residual coefficient, the flow proceeds to S270.

At S260, the bitrate estimation device 100 counts ‘0’ bit number (bnzero) of a context group according to the position of the read residual coefficient. For example, if the read residual coefficient is positioned in the first context group ctg0, the ‘0’ bit number of the first context group ctg0 is added by 1. Alternatively, if the read residual coefficient is positioned in the second context group ctg1, then the ‘0’ bit number of the second context group ctg1 is added by 1. Similarly, if the read residual coefficient is positioned in the third context group ctg2 or the fourth context group ctg3, then the ‘0’ bit number of the third context group ctg2 or the fourth context group ctg3 is added by 1.

After the ‘0’ bit number of the context group is counted according to the position of the read residual coefficient, the flow proceeds to S270.

At S270, the bitrate estimation device 100 determines whether all residual coefficients are read. If all residual coefficients are read, then the flow proceeds to S280. If it is not, then the flow returns to S220.

At S280, the bitrate estimation device 100 adjusts the number of bins of the context group according to the highest frequency coefficient or the last one of received residual coefficients (e.g., a sixteenth coefficient is the highest frequency coefficient in case of residual coefficients of 4×4 block). Specifically, if the highest frequency coefficient is a non-zero value, ‘1’ bit number of the last context group (herein, fourth context group) is subtracted by 1. If the highest frequency coefficient is zero, then the number of bins of the context group is not adjusted.

After the number of bins of the context group is adjusted, the flow is completed and the process terminates.

According to the foregoing, there is provided a method of deciding a context group for Significant_coefficient_flag and calculating the number of a context group.

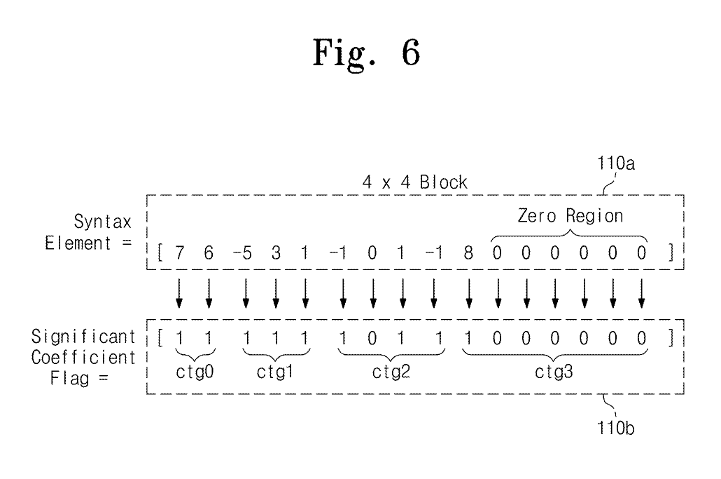

Reference is made to FIG. 6, which is a diagram further illustrating the example embodiment shown in FIG. 5. In FIG. 6, reference boxes 110a and 110b exemplarily represent a syntax element and binarized symbols according to the example embodiment shown in FIG. 5.

A residual coefficient is input as a syntax element together with the first reference box 110a. Of the other coefficients, a non-zero coefficient is binarized into 1 and a zero coefficient is binarized into 0. According to positions of binarized symbols, ‘0’ bit number or ‘1’ bit number is counted. For example, since a first coefficient ‘7’ is not zero, it is binarized into 1. And since its binarized symbol is positioned in a first context group ctg0, ‘1’ bit number of the first context group ctg0 is added by 1. The same binarization procedure and the same bin counting operation are carried out on the other coefficients.

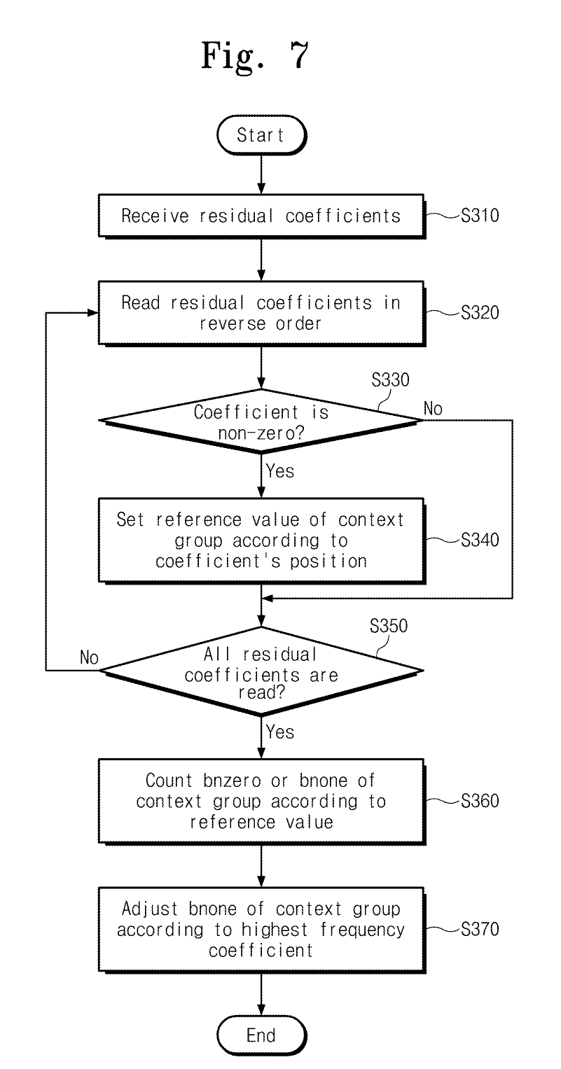

Reference is made to FIG. 7, which is a flowchart illustrating a bin counting method of a context group according to another example embodiment. The bin counting method includes S310 to S370.

At least this example embodiment of inventive concepts relates to Last_Significant_coefficient_flag in a context modeling method. In this example embodiment, a syntax element is a residual coefficient.

At S310, a bitrate estimation device 100 receives a residual coefficient as a syntax element. In at least some example embodiments, the residual coefficient may be received in a 4×4 block unit. The residual coefficient is the same as that defined in CABAC in the H.264/AVC standard.

At S320, the bitrate estimation device 100 reads received residual coefficients in reverse order. For example, when a residual coefficient is received in 4×4 block unit, the bitrate estimation device 100 reads a latest-received coefficient and then reads a first-received coefficient. In at least some example embodiments, the bitrate estimation device 100 performs a binarization operation for residual coefficients. In this case, a first-read one of non-zero residual coefficients is binarized into ‘1’ and the other residual coefficients are binarized into ‘0’. Meanwhile, residual coefficients belonging to the zero region are not binarized. During coding of the Last_Significant_coefficient_flag, the residual coefficients in the zero region are not binarized.

At S330, the bitrate estimation device 100 determines whether the read coefficient is a non-zero number. If the residual coefficient is a non-zero number, then the flow proceeds to S340. If it is not, then the flow proceeds to S350.

At S340, the bitrate estimation device 100 sets a reference value according to the position of the read residual coefficient. The reference value is a value referred to for counting the number of bins of each context group. One reference value is assigned to each context group. Hereinafter, a reference value of an Nth context group will be referred to as an Nth reference value.

The bitrate estimation device 100 increases a reference value of a context group, in which a non-zero residual coefficient is positioned, by 1. In this example embodiment, there is one residual efficient binarized into a non-zero number (i.e., binarized into ‘1’). Thus, only a reference value of one of all the context groups increases by 1.

If the reference value is decided according to the position of the residual efficient, then the flow proceeds to S350.

At S350, the bitrate estimation device 100 determines whether all the residual coefficients are read. If all the residual coefficients are read, then the flow proceeds to S360. If it is not, then the flow returns to S320.

At S360, the bitrate estimation device 100 counts the number of bins of the context group according to a reference value of the context group.

If reference values of all the context groups are zero, then ‘0’ bit number (bnzero) and ‘1’ bit number (bnone) of each context group are decided to be zero.

If a fourth reference value is not zero, then ‘1’ bit number of a fourth context group is decided to be 1 and ‘0’ bit number thereof is decided to be (fourth reference value −1). And ‘1’ bit number of the other context groups is decided to be 0, and ‘0’ bit number thereof is decided as a reference value of each context group (e.g., ‘0’ bit number of the second context group=second reference value).

If a third reference value is not zero and a fourth reference value is zero, then ‘1’ bit number of a third context group is decided to be 1 and ‘0’ bit number thereof is decided to be (third reference value −1). And ‘0’ bit number and ‘1’ bit number of a fourth context group are decided to be zero. And ‘1’ bit number of first and second context groups is decided to be zero and ‘0’ bit number thereof is decided as a reference value of each context group.

If a second reference value is not zero and third and four reference values are zero, then ‘1’ bit number of the second context group is decided to be 1 and ‘0’ bit number thereof is decided to be (second reference value −1). And ‘0’ bit number and ‘1’ bit number of the third and fourth context groups are decided to be zero. And ‘1’ bit number of the first context group is decided to be zero and ‘1’ bit number thereof is decided as a first reference value.

If the first reference value is not zero and second, third, and fourth reference values are zero, then ‘1’ bit number of the first context group is decided to be 1 and ‘0’ bit number thereof is decided to be (first reference value −1). And ‘0’ bit number and ‘1’ bit number of the second, third, and forth context groups are decided to be zero.

If the number of bins of each context group is decided in the above manner, then the flow proceeds to S370.

At S370, the bitrate estimation device 100 adjusts the number of bins of a context group according to the highest frequency coefficient. More specifically, if the highest frequency coefficient is a non-zero value, then ‘1’ bit number of the last context group (e.g., fourth context group) is adjusted to zero. If the highest frequency efficient is zero, then the number of bins of a context group is not adjusted.

After the number of bins of the context group is adjusted, the flow terminates.

According to the foregoing configuration, a method of deciding a context group for the Last_Significant_coefficient_flag and a bin counting method of the context group are provided.

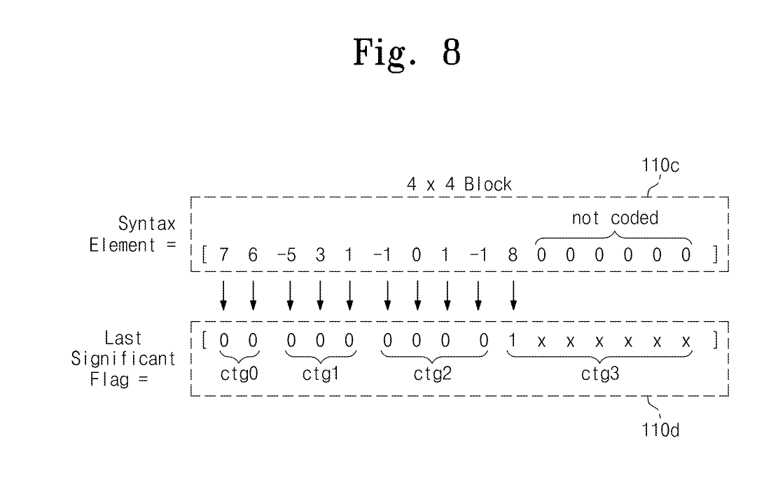

Reference is made to FIG. 8, which is a diagram further illustrating another example embodiment shown in FIG. 7. In FIG. 8, reference boxes 110c and 110d exemplarily represent a syntax element and binarized symbols according to the example embodiment shown in FIG. 7.

A residual coefficient is input as a syntax element together with a first reference box 110c. Six coefficients from behind belong to a zero region. During coding of Last_Significant_coefficient_flag, residual coefficients in the zero region are not binarized. When the other coefficients are read in reverse order, a first-read residual coefficient is binarized into ‘1’ and the other coefficients are binarized into ‘0’. A result of the binarization is shown in the second reference box 110d.

A reference value of each context group is counted according to the position of a symbol binarized into ‘1’. In FIG. 8, the symbol binarized into ‘1’ is positioned in the fourth context group ctg3. Thus, the fourth reference value may increase by 1.

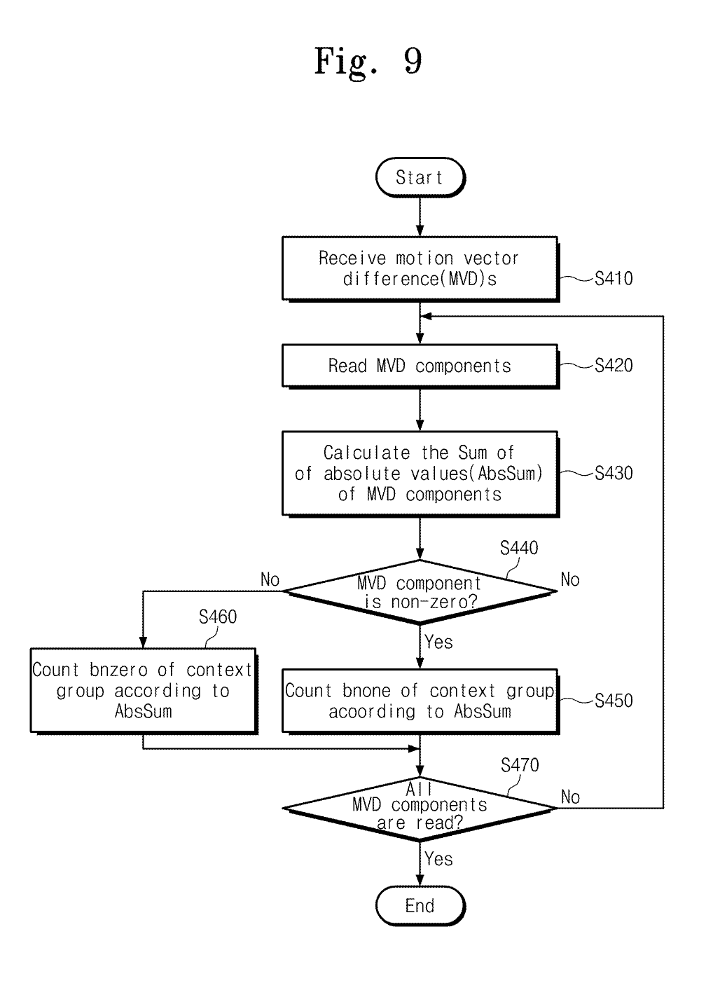

Reference is made to FIG. 9, which is a flowchart illustrating a bin counting method of a context group according to another example embodiment. In FIG. 9, the bin counting method includes S410 to S470.

The example embodiment shown in FIG. 9 relates to Significant_MVD_flag in a context modeling method. In this example embodiment, a syntax element is a motion vector difference (MVD).

At S410, a bitrate estimation device 100 receives an MVD as a syntax element. In at least some example embodiments, the MVD is received in a 4×4 block unit. The MVD is the same as that defined by the CABAC in the H.264/AVC standard.

At S420, the bitrate estimation device 100 sequentially reads MVD components. Because the MVD is an information vector, a pair of MVD components indicating each X-coordinate and Y-coordinate constitutes vector information. Hereinafter, a pair of MVD components indicating one vector information will be referred to as a vector component pair.

At S430, the bitrate estimation device 100 obtains absolute values of MVD components constituting a vector component pair and sums the obtained absolute values. The sum is decided as a reference value AbsSum of the vector component pair.

At S440, the bitrate estimation device 100 determines whether the MVD component is a non-zero value. If the MVD component is a non-zero value, then the flow proceeds to S450. If it is not, then the flow proceeds to S460.

At S450, the bitrate estimation device 100 counts ‘1’ bit number of a context group according to the absolute value AbsSum of the vector component pair. In this example embodiment, let it be assumed that there are three context groups.

In at least some example embodiments, the bitrate estimation device 100 counts ‘1’ bit number of the context group by comparing the reference value AbsSum of the vector component pair with a first or second comparison value. The first or second comparison value is a given, desired or predetermined value. Specifically, if the reference value AbsSum of the vector component pair is less than or equal to the first comparison value (AbsSum≦first comparison value), then the bitrate estimation device 100 adds ‘1’ bit number of a first context group by 1. If the reference value AbsSum of the vector component pair is greater than the first comparison value and less than or equal to the second comparison value (first comparison value+1≦AbsSum≦second comparison value), then the bitrate estimation device 100 adds ‘1’ bit number of a second context group by 1. If the reference value AbsSum of the vector component pair is greater than the second comparison value (second comparison value+1≦AbsSum), then the bitrate estimation device 100 adds ‘1’ bit number of a third context group by 1.

When an operation of counting the ‘1’ bit number of the context group is completed, the flow proceeds to S470.

At S460, the bitrate estimation device 100 counts ‘0’ bit number of a context group according to the reference value AbsSum of the vector component pair included in the MVD component.

In at least some example embodiments, the bitrate estimation device 100 counts ‘0’ bit number of a context group by comparing the reference value AbsSum of the vector component pair with the first or second comparison value. The first and second comparison value is a given, desired or predetermined value.

More specifically, if the reference value AbsSum of the vector component pair is less than or equal to the first comparison value (AbsSum≦first comparison value), then the bitrate estimation device 100 adds ‘0’ bit number of a first context group by 1.

If the reference value AbsSum of the vector component pair is greater than the first comparison value and less than or equal to the second comparison value (first comparison value+1≦AbsSum≦second comparison value), then the bitrate estimation device 100 adds ‘0’ bit number of a second context group by 1.

If the reference value AbsSum of the vector component pair is greater than the second comparison value (second comparison value+1≦AbsSum), then the bitrate estimation device 100 adds ‘0’ bit number of a third context group by 1.

When an operation of counting the ‘0’ bit number of the context group is completed, the flow proceeds to S470.

At S470, the bitrate estimation device 100 determines whether all MVD components are read. If there is an unread MVD component, then the flow proceeds to S420. If it is not, then the flow terminates.

According to the foregoing configuration, a method of deciding a context group for Significant_MVD_flag and a bin counting method of the context group are provided.

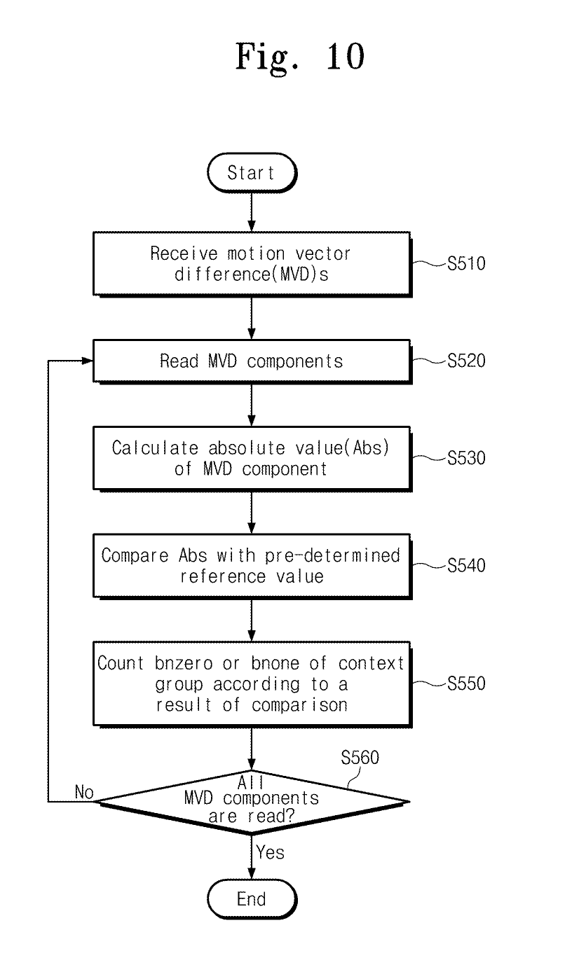

Reference is made to FIG. 10, which is a flowchart illustrating a bin counting method of a context group according to another example embodiment. In FIG. 10, the bin counting method includes S510 to S560.

The example embodiment shown in FIG. 10 relates to MVD_absolute_level in a context modeling method. In this example embodiment, a syntax element is a motion vector difference (MVD).

At S510, a bitrate estimation device 100 receives an MVD as a syntax element. In at least some example embodiments, the MVD is received in a 4×4 block unit. The MVD is the same as that defined in the CABAC in the H.264/AVC standard.

At S520, the bitrate estimation device 100 sequentially reads MVD components.

At S530, the bitrate estimation device 100 obtains absolute values of MVD. The obtained absolute values are decided as reference values Abs of the MVD components.

At S540 and S550, the bitrate estimation device 100 counts ‘1’ bit number or ‘0’ bit number of a context group based on the reference value Abs. In at least this example embodiment, let it be assumed that there are three context groups. The reference value Abs is an integer greater than or equal to 1. In the case that the reference value Abs is zero, this case is excluded in the bin counting method.

More specifically, at S540 the bitrate estimation device 100 compares the reference value Abs with a first, second or third comparison value. The first, second, and third values are given, desired or predetermined values. At S550, the bitrate estimation device 100 counts ‘1’ bit number or ‘0’ bit number of a context group according to a result of the comparison.

In at least some example embodiments, if the reference value Abs is less than or equal to the first comparison value, then the bitrate estimation device 100 adds ‘0’ bit number of a first context number by 1 and adds ‘1’ bit number thereof by (Abs−1).

If the reference value Abs is greater than or equal to the first comparison value and less than or equal to the second comparison value (first comparison value+1≦Abs≦second comparison value), then the bitrate estimation device 100 adds ‘1’ bit number of the first context group by 1. And the bitrate estimation device 100 adds ‘0’ bit number of the second context group by 1 and adds ‘1’ bit number thereof by (Abs−first comparison value −1).

If the reference value Abs is greater than or equal to the second comparison value and less than or equal to the third comparison value (second comparison value +1≦Abs≦third comparison value), then the bitrate estimation device 100 adds ‘1’ bit number of the first context group by 1. And the bitrate estimation device 100 adds ‘1’ bit number of the second context group by (second comparison value−first comparison value). And the bitrate estimation device 100 adds ‘0’ bit number of the third context group by 1 and ‘1’ bit number thereof by (Abs−second comparison value −1).

If the reference value is greater than or equal to the third comparison value (third comparison value +1≦Abs), then the bitrate estimation device 100 adds ‘1’ bit number of the first context group by the first comparison value. And the bitrate estimation device 100 adds ‘1’ bit number of the second context group by (second comparison value−first comparison value). And the bitrate estimation device 100 adds ‘1’ bit number of the third context group by (third comparison value−second comparison value).

When the operation of counting the bit number of a context group is completed, the flow proceeds to S560.

At S560, the bitrate estimation device 100 determines whether all MVD components are read. If there is an unread MVD component, then the flow proceeds to S520. If it is not, then the flow terminates.

According to the foregoing configuration, a method of deciding a context group for MVD_absolute_level and a bin counting method of the context group are provided.

Reference is made to FIG. 11, which illustrates an absolute value or the sum of absolute values according to another example embodiment. In FIG. 11, reference boxes 110e, 110f, and 110g represent a syntax element and reference values Abs and AbsSum, respectively.

The first reference box 110e represents MVD components as a syntax element. Two MVD components indicating single vector information may be considered a single pair. For example, two MVD components 7 and −6 positioned at the most front may be considered a single vector component pair as an X-axis value and a Y-axis value on the single vector information.

The second reference box 110f represents absolute values of the MVD components. An absolute value Abs is used as a reference value.

The third reference box 110g represents the sum of absolute values for a single vector component pair. For example, the sum AbsSum of absolute values for a first vector component pair (7 and −6) is added to absolute values 7 and 6 to be 13. The absolute value AbsSum of the absolute value is used as another reference value.

The details of the reference values Abs and AbsSum are the same or substantially the same as described above.

Reference is made to FIG. 12, which is a block diagram of the bitrate calculating unit 120 shown in FIG. 3. The bitrate calculating unit 120 includes a first look-up table 121 and a second look-up table 122.

The first look-up table 121 is a table for normalizing the number of symbol bins (bns), and the second look-up table 122 is a table for deciding average bit amount of CABAC from the number of symbol bins (bns).

The bitrate calculating unit 120 normalizes the number of input symbol bins (bns) using the first look-up table 121 and provides a result of the normalization to the bin counting unit 110 as a feedback signal. The reason for normalizing the number of symbol bins (bns) is the same as that described in FIG. 3. The provided feedback signal is used to count the number of symbol bins for the next syntax element.

By using the second look-up table 122, the bitrate calculating unit 120 decides average bit amount of ‘0’ bit and average bit amount of ‘1’ bit of CABAC from ‘0’ bit number and ‘1’ bit number of the number of symbol bins (bns).

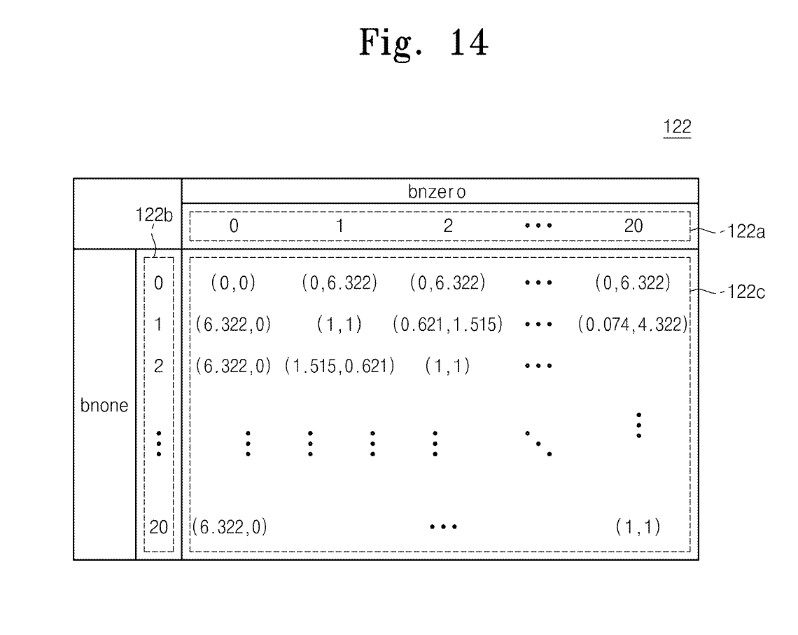

The first and second look-up tables 121 and 122 will be described in detail later with reference to FIGS. 13 and 14.

The bitrate calculating unit 120 calculates an estimated bitrate of CABAC by multiplying the decided average bitrate by the number of bins. The bitrate calculating unit 120 calculates an estimated bitrate from the number of symbol bins (bns) and average bit amount in the same or substantially the same manner as described in Equation (1).

According to the foregoing configuration, the bitrate calculating unit 120 decides average bit amount using a look-up table. Thus, use frequency of a logic operation and four arithmetical operations may be decreased and/or minimized to reduce complexity of a bitrate estimation device and/or a bitrate estimation method and improve operating speed thereof.

Reference is made to FIG. 13, which illustrates the first look-up table 121 shown in FIG. 12. The first look-up table 121 includes a ‘0’ bit field 121a, a ‘1’ bit field 121b, and a normalization field 121c.

The ‘0’ bit field 121a denotes ‘0’ bit number of the number of symbol bins (bns).

The ‘0’ bit field 121b denotes ‘1’ bit number of the number of symbol bins (bns).

The normalization field 121c denotes normalized ‘0’ bit number and normalized ‘1’ bit number that are decided according to the ‘0’ bit number and the ‘1’ bit number of the number of symbol bins (bns).

A bitrate calculating unit 120 decides the number of normalized bins corresponding to ‘0’ bit number and ‘1’ bit number of the number of symbol bins (bns). For example, when ‘0’ bit number of the bns 1 and ‘1’ bit number thereof is 2, (13,7) that is a value of third row and second column of the normalization field 121c is derived by the first look-up table 121. In this example, the normalized ‘1’ bit number is 13 and the normalized ‘0’ bit number is 7.

In FIG. 13, the normalization field 121c is defined such that ‘0’ bit number and ‘1’ bit number of the bns are proportional to normalized ‘0’ bit or ‘1’ bit number and the sum of the normalized ‘1’ bit number and the normalized ‘0’ bit number is 20. For example, when the ‘0’ bit number and the ‘1’ bit number of the bns are equal or substantially equal to each other, a corresponding normalization field value is defined as (10,10). When the ‘0’ bit number of the bns is 0, a corresponding normalization field value is defined as (20,0). Meanwhile, when the ‘1’ bit number of the bns is 0, a corresponding normalization field value is defined as (0,20). When both the ‘0’ bit number and the ‘0’ bit number of the bns are 0, it is normalized as (0,0).

In at least some example embodiments, in FIG. 13, ‘0’ bit number (bnzero) or ‘1’ bit number (bnone) is limited up to about 40. In this case, when the ‘0’ bit number or the ‘1’ bit number exceeds 40, the exceeding number is regarded as about 40. That is, the maximum of the ‘0’ bit number (or the ‘1’ bit number) is 40. The value ‘40’ is a given, desired or predetermined number for convenience of production of the look-up table 121. In addition, the value ‘40’ is exemplary and may vary.

According to the foregoing configuration, a look-up table is provided for normalizing the number of symbol bins (bns).

FIG. 14 illustrates the second look-up table 122 shown in FIG. 12. The second look-up table 122 includes a ‘0’ bit field 122a, a 1’ bit field 122b, and an average bit amount field 122c.

The ‘0’ bit field 122a denotes ‘0’ bit number of the number of symbol bins (bns).

The ‘0’ bit field 122b denotes ‘1’ bit number of the number of symbol bins (bns).

The average bit amount field 122c denotes average bit amount of ‘0’ bit number and ‘1’ bit number that are decided according to the ‘0’ bit number and the ‘1’ bit number of the number of symbol bins (bns).

A bitrate calculating unit 120 decides corresponding average bit amount according to ‘0’ bit number and ‘1’ bit number of the bns with reference to second look-up table 122. For example, when the ‘0’ bit number of the bns 1 and the ‘1’ bit number thereof is 2, a value of third row and second column (1.515, 0.6217) is derived by the second look-up table 122. In this example, the average bit amount of the ‘1’ bit number is about 1.515 and average bit amount of the ‘0’ bit number is about 0.6217.

The average bit amount field 122c is defined by Equation (2) below.

Average bit amount of ‘0’ bit=[log(probability of ‘0’ bit)]/log(0.5)

Average bit amount of ‘1’ bit=[log(1−probability of ‘0’ bit)]/log(0.5) Equation (2)

wherein log is a common logarithm.

In Equation (2), the probability of ‘0’ bit may be calculated from ‘0’ bit number and ‘1’ bit number by Equation (3) below.

Probability of ‘0’ bit=‘0’ bit number/(‘1’ bit number+‘1’ bit number) Equation (3)

Hereinafter, an average bit amount corresponding to a case where ‘0’ bit number=2 and ‘1’ bit number=1 will now be exemplarily calculated with reference to Equations (2) and (3).

According to Equation (3), the probability of ‘0’ bit=2/(2+1)=0.667. If the probability of ‘1’ bit number and the probability of ‘0’ bit number are substituted into Equation (2), then a result is obtained as shown in Equation (4) below.

Average bit amount of ‘0’ bit=log(0.667)/log(0/5)=1.515 Equation (4)

Average bit amount of ‘1’ bit=log(0.333)/log(0/5)=0.621

Thus, a value of third row and second column that is a value of the corresponding average bit amount field 122c is defined as (1.515, 0.6217). If average bit amount values corresponding to all the set ‘0’ bit number and ‘1’ bit number are calculated, then the average bit amount field 122c in FIG. 14 may be defined.

In at least some example embodiments, in FIG. 14, ‘0’ bit number (bnzero) or ‘1’ bit number (bnone) is limited up to 20. In this case, when the ‘0’ bit number or the ‘1’ bit number exceeds 20, the exceeding number is regarded as 20. That is, the maximum of the ‘0’ bit number (or the ‘1’ bit number) is about 40. The value ‘20’ is a given, desired or predetermined number for convenience of production of the look-up table 122. In addition, the value ‘40’ is exemplary and may vary.

According to the foregoing configuration, a look-up table is provided for deciding average bit amount of ‘0’ bit and ‘1’ bit.

As described above, example embodiments provide bitrate estimation devices with simplified computation and bitrate estimation methods thereof. In addition, bitrate estimation speed may be improved. Furthermore, accuracy of bitrate estimation devices and bitrate estimation methods thereof may be enhanced.

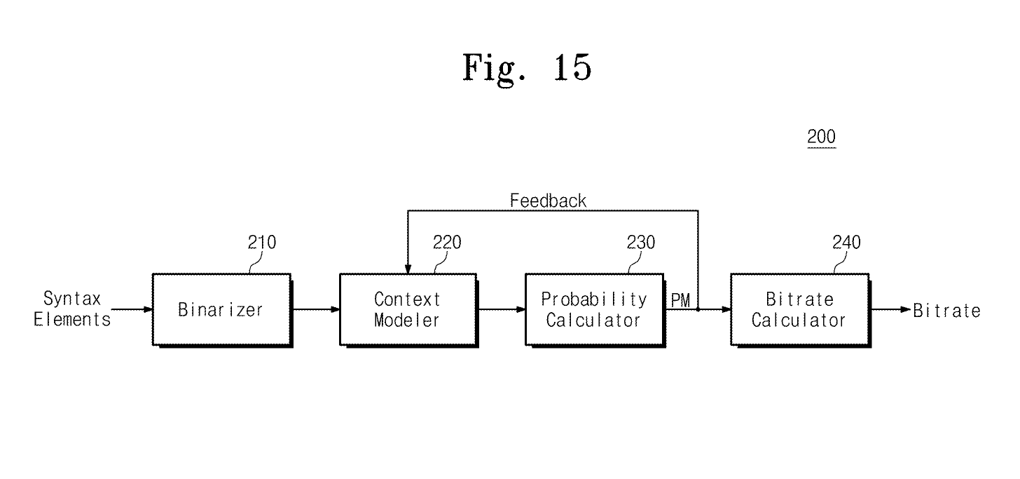

Reference is made to FIG. 15, which is a block diagram of a CABAC bitrate estimation device according to an example embodiment. As illustrated, the CABAC bitrate estimation device includes a binarizer 210, a context modeler 220, a probability calculator 230, and a bitrate calculator 240.

The detailed configurations and operations of the binarizer 210 and the context modeler 220 are the same or substantially the same as those of the binarizer 21 and the context modeler 22 described in FIG. 2.

The probability calculator 230 receives a context-modeled bin and a bit probability of the bin from the context modeler 22 and calculates a statistical parameter PM. The statistical parameter PM may include an interval of a context model, a bit probability (probability of ‘0’ bit or ‘1’ bit), a most probable symbol (MPS) or least probable symbol (LPS). The calculated statistical parameter PM is provided to the bitrate calculator 240.

The bitrate calculator 240 estimates a bitrate using an LPS look-up table when the context-modeled bin is an LPS. On the other hand, the bitrate calculator 240 estimates a bitrate using an MPS look-up table when the context-modeled bin is an MPS. Specifically, the bitrate calculator 240 searches a mapping value corresponding to the received statistical parameter PM in a look-up table and estimates the searched mapping value as a bitrate.

The look-up table is defined by Equation (5) below.

Bitrate=m−1−[logₙ(i)] [Equation 5]

wherein m represents a bit size of an interval, n represents an antilogarithm of a symbol, and i represents an interval. And └A┘ means a maximum integer that is not greater than A.

The interval i may be obtained with reference to an interval table of LPS defined by the CABAC in the H.264/AVC standard.

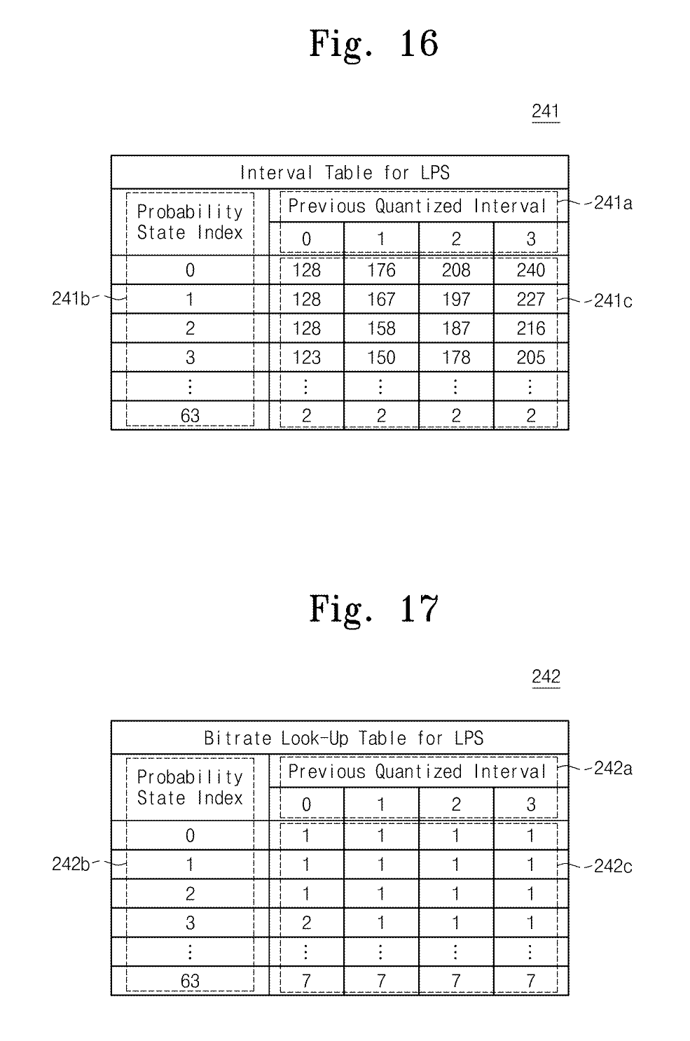

The LPS look-up table, the MPS look-up table, and the interval table will be described in detail later with reference to FIGS. 16 to 18.

According to the foregoing configuration, the bitrate calculator 240 estimates a CABAC bitrate using a look-up table. Thus, use frequency of a log operation and four arithmetical operations may be reduced and/or minimized to reduce complexity of bitrate estimation devices and bitrate estimation methods and/or improve operating speed thereof.

In addition, the bitrate calculator 240 refers to an LPS interval table defined by the CABAC in the H.264/AVC standard to define an LPS look-up table and an MPS look-up table. Thus, advantageously, characteristics of the CABAC are reflected on the look-up table and a bitrate estimated by the bitrate calculator 240 follows the characteristics of the CABAC.

Reference is made to FIG. 16, which illustrates an interval table 241 of CABAC in the H.264/AVC standard. As illustrated, the interval table 241 includes an interval range field 241a, a probability state index field 241b, and an interval field 241c.

Of the CABAC interval table, an LPS interval table will be described in FIG. 16.

The interval range field 241a is a field indicating an interval range in which an interval of a previous symbol is classified into a plurality of ranges.

The probability state index field 241b is a field indicating a probability state index corresponding to a bit probability of an LPS. The higher the bit probability, the greater a corresponding probability state index value.

The interval field 241c is a field indicating an interval value corresponding to an interval range value and a probability state index value. For example, when an interval range is 1 and a probability state index is 3, an interval value is 150 corresponding to a value of fourth row and second column in the interval field 241c.

The interval table 241, the interval range field 241a, the probability state index field 241b, and the interval field 241c are defined according to the standard of CABAC in the H.264/AVC standard and will not be described in further detail.

Reference is made to FIG. 17, which illustrates a look-up table 242 for a bitrate estimation method according to the example embodiment shown in FIG. 15. As illustrated, the look-up table 242 includes an interval range field 242a, a probability state index field 242b, and a bitrate field 242c.

The interval range field 242a and the probability index field 242b are the same or substantially the same as the interval range field 241a and the probability state index field 241b described in FIG. 16, respectively.

The bitrate field 242c is defined by the interval field 241c in FIG. 16 and Equation (5). More, specifically, in Equation (5), the bitrate field 242c is defined by a bitrate obtained by substituting an interval bit size to m, substituting an antilogarithm of a symbol to n, and substituting a value of the interval field 241c to i.

Hereinafter, a method of obtaining a value of the bitrate field 242c will now be described.

Let it be assumed that a bitrate field value is obtained when an interval range value 1 and a probability state index field value is 3 in a look-up table. According to the assumption, an interval range value may be obtained from an interval value of a previous symbol and a probability state index field value and an LPS value may be obtained from a statistical parameter PM (see FIG. 15).

In the standard of CABAC in the H.264/AVC standard, an interval is a value expressed as 9 bits and a symbol is defined as a binarized value. Thus, m=9 and n=2 in Equation (5). The interval is obtained from the interval field 241c in FIG. 16. Referring to FIG. 16, an interval value corresponding to (interval range value=1) and (probability state index field value=3) is 150. Thus, i=150 in Equation (5).

If the above values are substituted into Equation (5), a bitrate=9−1−└log₂(150)┘=9−1−7=1. Thus, a corresponding value (value of fourth row and second column) of the bitrate field 242c is defined as 1.

If a value corresponding to the interval range field 242c and the probability state index field 242b is obtained in the same manner, then the look-up table 242 in FIG. 17 is defined.

The overall configuration of the look-up table 242 obtained by the above method is shown in the Table (2) below.

TABLE 2

| | |
|---|---|
| Probability | Previous Quantized Interval |

| state index | 0 | 1 | 2 | 3 |
|---|---|---|---|---|
| 0 | 1 | 1 | 1 | 1 |
| 1 | 1 | 1 | 1 | 1 |
| 2 | 1 | 1 | 1 | 1 |
| 3 | 2 | 1 | 1 | 1 |
| 4 | 2 | 1 | 1 | 1 |
| 5 | 2 | 1 | 1 | 1 |
| 6 | 2 | 1 | 1 | 1 |
| 7 | 2 | 2 | 1 | 1 |
| 8 | 2 | 2 | 1 | 1 |
| 9 | 2 | 2 | 1 | 1 |
| 10 | 2 | 2 | 2 | 1 |
| 11 | 2 | 2 | 2 | 1 |
| 12 | 2 | 2 | 2 | 1 |
| 13 | 2 | 2 | 2 | 2 |
| 14 | 2 | 2 | 2 | 2 |
| 15 | 2 | 2 | 2 | 2 |
| 16 | 3 | 2 | 2 | 2 |
| 17 | 3 | 2 | 2 | 2 |
| 18 | 3 | 2 | 2 | 2 |
| 19 | 3 | 2 | 2 | 2 |
| 20 | 3 | 3 | 2 | 2 |
| 21 | 3 | 3 | 2 | 2 |
| 22 | 3 | 3 | 2 | 2 |
| 23 | 3 | 3 | 2 | 2 |
| 24 | 3 | 3 | 3 | 2 |
| 25 | 3 | 3 | 3 | 2 |
| 26 | 3 | 3 | 3 | 3 |
| 27 | 3 | 3 | 3 | 3 |
| 28 | 3 | 3 | 3 | 3 |
| 29 | 3 | 3 | 3 | 3 |
| 30 | 4 | 3 | 3 | 3 |
| 31 | 4 | 3 | 3 | 3 |
| 32 | 4 | 3 | 3 | 3 |
| 33 | 4 | 4 | 3 | 3 |
| 34 | 4 | 4 | 3 | 3 |
| 35 | 4 | 4 | 3 | 3 |
| 36 | 4 | 4 | 3 | 3 |
| 37 | 4 | 4 | 4 | 3 |
| 38 | 4 | 4 | 4 | 3 |
| 39 | 4 | 4 | 4 | 4 |
| 40 | 4 | 4 | 4 | 4 |
| 41 | 4 | 4 | 4 | 4 |
| 42 | 4 | 4 | 4 | 4 |
| 43 | 5 | 4 | 4 | 4 |
| 44 | 5 | 4 | 4 | 4 |
| 45 | 5 | 4 | 4 | 4 |
| 46 | 5 | 4 | 4 | 4 |
| 47 | 5 | 5 | 4 | 4 |
| 48 | 5 | 5 | 4 | 4 |
| 49 | 5 | 5 | 4 | 4 |
| 50 | 5 | 5 | 5 | 4 |
| 51 | 5 | 5 | 5 | 4 |
| 52 | 5 | 5 | 5 | 4 |
| 53 | 5 | 5 | 5 | 5 |
| 54 | 5 | 5 | 5 | 5 |
| 55 | 5 | 5 | 5 | 5 |
| 56 | 5 | 5 | 5 | 5 |
| 57 | 6 | 5 | 5 | 5 |
| 58 | 6 | 5 | 5 | 5 |
| 59 | 6 | 5 | 5 | 5 |
| 60 | 6 | 5 | 5 | 5 |
| 61 | 6 | 6 | 5 | 5 |
| 62 | 6 | 6 | 5 | 5 |
| 63 | 7 | 7 | 7 | 7 |

The above table is a look-up table for obtaining a bitrate when a context-modeled bin is an LPS.

The next explanation is directed to a look-up table when a bin is an MPS. Here, CABAC of H.264/AVC does not include an interval table of the MPS. Thus, an MPS look-up table is obtained using the interval table of the MPS.

More specifically, an interval of the MPS is obtained by subtracting an interval of a current LPS from an interval of a previous LPS. If the obtained interval of the MPS is substituted to the interval i in Equation (5), then a bitrate of the MPS is calculated.

For example, let it be assumed that a previous quantized interval of an LPS is 2 and a probability state index is 2. When a previous quantized interval of an LPS is 0, an original range is 256 to 319. When a previous quantized interval of an LPS is 1, an original range is 320 to 383. When a previous quantized interval of an LPS is 2, an original range is 384 to 447. When a previous quantized interval of an LPS is 3, an original range is 448 to 511. In this case, since the previous quantized interval of an LPS is 2, an original interval of the LPS is a value ranging from 384 to 447. As shown in FIG. 16, when the probability state index is 2 and the previous quantized interval of the LPS is 2, the current LPS interval is 187. Thus, an interval range of the MPS is 197 to 260. If 228.5 corresponding to its intermediate value is substituted into Equation (5), the bitrate of the MPS is calculated to be 1.

An MPS look-up table produced by the above method may be shown in the Table (3).

TABLE 3

| | |
|---|---|
| Probability | Previous Quantized Interval |

| state index | 0 | 1 | 2 | 3 |
|---|---|---|---|---|
| 0 | 1 | 1 | 1 | 1 |
| 1 | 1 | 1 | 1 | 1 |
| 2 | 1 | 1 | 1 | 0 |
| 3 | 1 | 1 | 1 | 0 |
| 4 | 1 | 1 | 1 | 0 |
| 5 | 1 | 1 | 1 | 0 |
| 6 | 1 | 1 | 0 | 0 |
| 7 | 1 | 1 | 0 | 0 |
| 8 | 1 | 1 | 0 | 0 |
| 9 | 1 | 1 | 0 | 0 |
| 10 | 1 | 1 | 0 | 0 |
| 11 | 1 | 1 | 0 | 0 |
| 12 | 1 | 1 | 0 | 0 |
| 13 | 1 | 0 | 0 | 0 |
| 14 | 1 | 0 | 0 | 0 |
| 15 | 1 | 0 | 0 | 0 |
| 16 | 1 | 0 | 0 | 0 |
| 17 | 1 | 0 | 0 | 0 |
| 18 | 1 | 0 | 0 | 0 |
| 19 | 1 | 0 | 0 | 0 |
| 20 | 1 | 0 | 0 | 0 |
| 21 | 1 | 0 | 0 | 0 |
| 22 | 1 | 0 | 0 | 0 |
| 23 | 1 | 0 | 0 | 0 |
| 24 | 1 | 0 | 0 | 0 |
| 25 | 0 | 0 | 0 | 0 |
| 26 | 0 | 0 | 0 | 0 |
| 27 | 0 | 0 | 0 | 0 |
| 28 | 0 | 0 | 0 | 0 |
| 29 | 0 | 0 | 0 | 0 |
| 30 | 0 | 0 | 0 | 0 |
| 31 | 0 | 0 | 0 | 0 |
| 32 | 0 | 0 | 0 | 0 |
| 33 | 0 | 0 | 0 | 0 |
| 34 | 0 | 0 | 0 | 0 |
| 35 | 0 | 0 | 0 | 0 |
| 36 | 0 | 0 | 0 | 0 |
| 37 | 0 | 0 | 0 | 0 |
| 38 | 0 | 0 | 0 | 0 |
| 39 | 0 | 0 | 0 | 0 |
| 40 | 0 | 0 | 0 | 0 |
| 41 | 0 | 0 | 0 | 0 |
| 42 | 0 | 0 | 0 | 0 |
| 43 | 0 | 0 | 0 | 0 |
| 44 | 0 | 0 | 0 | 0 |
| 45 | 0 | 0 | 0 | 0 |
| 46 | 0 | 0 | 0 | 0 |
| 47 | 0 | 0 | 0 | 0 |
| 48 | 0 | 0 | 0 | 0 |
| 49 | 0 | 0 | 0 | 0 |
| 50 | 0 | 0 | 0 | 0 |
| 51 | 0 | 0 | 0 | 0 |
| 52 | 0 | 0 | 0 | 0 |
| 53 | 0 | 0 | 0 | 0 |
| 54 | 0 | 0 | 0 | 0 |
| 55 | 0 | 0 | 0 | 0 |
| 56 | 0 | 0 | 0 | 0 |
| 57 | 0 | 0 | 0 | 0 |
| 58 | 0 | 0 | 0 | 0 |
| 59 | 0 | 0 | 0 | 0 |
| 60 | 0 | 0 | 0 | 0 |
| 61 | 0 | 0 | 0 | 0 |
| 62 | 0 | 0 | 0 | 0 |
| 63 | 0 | 0 | 0 | 0 |

According to the foregoing configuration, a look-up table used to obtain a bitrate in the fifth embodiment is provided.

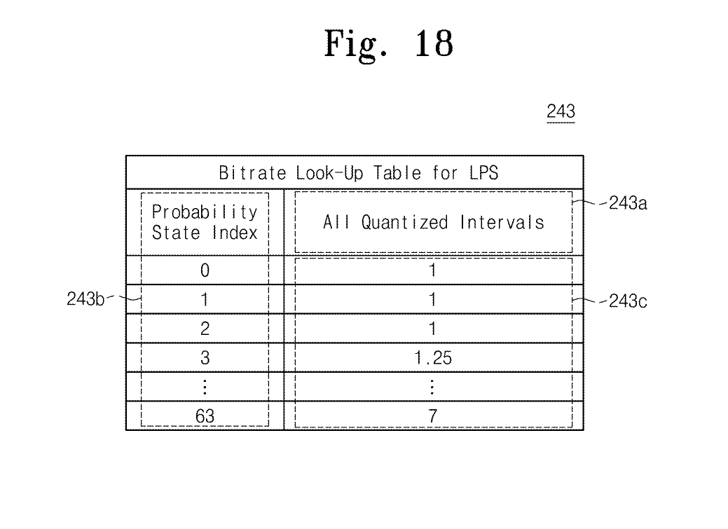

Reference is made to FIG. 18, which illustrates a look-up table 243 for a bitrate estimation method according to another example embodiment. As illustrated, the look-up table 243 includes an interval range field 243a, a field state field 243b, and a bitrate field 243c.

In at least this example embodiment, the look-up table 243 is defined without considering an interval range value of a previous symbol. Thus, the interval range field 243a may be omitted.

The probability state field 243b is to the same or substantially the same as the probability state field 242b in FIG. 17.

The bitrate field 243c is simpler than the bitrate field 242c in FIG. 17. More specifically, by taking an average of bitrate values positioned at the same row of the bitrate rate field 242c in FIG. 17, its result is defined as a bitrate value of the row.

For example, bitrate values positioned at the fourth row of the bitrate field 242c in FIG. 17 are sequentially 2, 1, 1, and 1. In at least this example embodiment, an average of these values ([2+1+1+1]/4=1.25) is obtained and the average is defined as a value of the fourth row of the bitrate field 243c. If all rows of the bitrate field 242c in FIG. 17 are subjected to the same procedure, then the bitrate field 243c may be defined.

Also an MPS look-up table may be obtained in the same or substantially the same manner as in the example embodiment described above.

The look-up table 243 according to at least this example embodiment estimates a bitrate with reference to only a probability state index value. Thus, computation of estimating a bitrate may be further simplified.

According to at least some example embodiments, bitrate estimation devices with simplified computation and bitrate estimation methods thereof may be provided. In addition, bitrate estimation speed may be improved. Furthermore, bitrate estimation devices with improved estimation accuracy and/or bitrate estimation methods thereof can be provided.

While inventive concepts have been particularly shown and described with reference to some example embodiments thereof, it will be apparent to those of ordinary skill in the art that various changes in form and detail may be made therein without departing from the spirit and scope of inventive concepts as defined by the following claims.

What is claimed is:

1. A method for estimating a bitrate of a coding device, comprising:
calculating the number of symbol bins of a received syntax element;
determining an average bit amount corresponding to the number of symbol bins using a look-up table; and
estimating the bitrate of the coding device based on the number of symbol bins and the average bit amount.

2. The method as set forth in claim 1, wherein the calculating a number of symbol bins comprises:
identifying a context group of the syntax element; and
calculating the number of symbol bins of the context group,
wherein the context group includes at least one context model of a context-based adaptive binary arithmetic coding.

3. The method as set forth in claim 2, wherein the calculating a number of symbol bins further comprises:
summing the calculated number of symbol bins of the context group and the number of symbol bins of a feedback signal.

4. The method as set forth in claim 3, wherein the number of symbol bins of a feedback signal is a normalized number.

5. The method as set forth in claim 2, wherein the identifying a context group comprises:
identifying a binary code corresponding to the syntax element; and
identifying the context group of the syntax element based on a value of the binary code or a position of the binary code.

6. The method as set forth in claim 5, wherein the context element is a residual coefficient.

7. The method as set forth in claim 2, wherein the identifying a context group comprises:
identifying a first value according to an absolute value of the syntax element; and
identifying a context group of the syntax element by comparing the first value with a second value.

8. The method as set forth in claim 7, wherein the syntax element is a motion vector difference.

9. The method as set forth in claim 1, wherein the look-up table is defined by a first equation (average bit amount of ‘0’ bit=[log(probability of ‘0’ bit)]/log(0.5)) or a second equation (average bit amount of ‘1’ bit=[log(1−probability of ‘0’ bit)]/log(0.5)).

10. The method as set forth in claim 9, wherein the probability of ‘0’ bit is defined by a third equation (probability of ‘0’ bit=‘0’ bit number/(‘0’ bit number+‘1’ bit number)).

11. The method as set forth in claim 1, wherein the coding device is a context-based adaptive binary arithmetic device.

12. A method for estimating a bitrate of a context-based binary arithmetic (CABAC) device, comprising:
selecting a context model of a received syntax element;
calculating a statistical parameter of the context model based on the context model; and
determining a bitrate corresponding to the statistical parameter using a look-up table.

13. The method as set forth in claim 12, wherein the statistical parameter includes an interval of the context model, a bit probability, a most probable symbol or a least portable symbol.

14. The method as set forth in claim 13, wherein the look-up table is defined based on an equation (bitrate=m−1−└logₙ(i)┘), where i is an interval, m is a bit size of the interval, and n is an antilogarithm of a symbol.

15. The method as set forth in claim 14, wherein the look-up table is defined based on an interval table of CABAC in the H.264/AVC standard.

16. A method for estimating a bitrate of a coding device, the method comprising:
estimating the bitrate of the coding device based on a number of symbol bins of a received syntax element without calculating bit probabilities for the symbol bins of the received syntax element.

17. The method as set forth in claim 16, wherein the estimating comprises:
calculating the number of symbol bins of the received syntax element;
determining an average bit amount corresponding to the number of symbol bins using a look-up table; and wherein
the bitrate of the coding device is estimated based on the number of symbol bins and the determined average bit amount.

18. The method as set forth in claim 17, wherein the calculating the number of symbol bins comprises:
identifying a context group of the syntax element; and
calculating the number of symbol bins of the context group, wherein
the context group includes at least one context model of a context-based adaptive binary arithmetic coding.

19. The method as set forth in claim 18, wherein the identifying a context group comprises:
identifying a binary code corresponding to the syntax element; and
identifying a context group of the syntax element based on a value of the binary code or a position of the binary code.

20. A method for estimating a bitrate of a coding device, the method comprising:
estimating the bitrate of the coding device based on a calculated number of symbol bins of a received syntax element and an average bit amount for the symbol bins, the average bit amount for the symbol bins being determined using a look-up table.

21. The method as set forth in claim 20, further comprising:
identifying a context group of the syntax element; and
calculating the number of symbol bins of the received syntax element based on a number of symbol bins of the context group, wherein
the context group includes at least one context model of a context-based adaptive binary arithmetic coding.

22. The method as set forth in claim 21, wherein the identifying a context group comprises:
identifying a binary code corresponding to the syntax element; and
identifying the context group of the syntax element based on a value of the binary code or a position of the binary code.

23. A method for estimating a bitrate of a coding device, the method comprising:
identifying a context group of a received syntax element; and
estimating the bitrate of the coding device based on a number of symbol bins of the context group, the context group including at least one context model of a context-based adaptive binary arithmetic coding.

24. The method as set forth in claim 23, wherein the estimating comprises:
calculating a number of symbol bins of the received syntax element based on the number of bins of the context group; and wherein
the bitrate of the coding device is estimated based on the number of symbol bins and an average bit amount for the symbol bins.

25. The method as set forth in claim 24, wherein the average bit amount for the symbol bins is determined using a look-up table.

26. A method for estimating a bitrate of a context-based binary arithmetic (CABAC) device, the method comprising:
estimating the bitrate of the CABAC device based on a statistical parameter for a context model of a received syntax element using a look-up table.

27. The method as set forth in claim 26, wherein the statistical parameter includes an interval of the context model, a bit probability, a most probable symbol or a least portable symbol.
